(19) United States
(12) Patent Application Publication
(10) Pub. No.: US 2014/0372904 A1
(43) Pub. Date: Dec. 18, 2014

(54) SYSTEM AND METHOD FOR COMMUNICATING TRANSPORTATION EVENTS

(71) Applicants: Sean Liu, Sunnyvale, CA (US); Yiyang Joy Ding, Brooklyn, NY (US)

(72) Inventors: Sean Liu, Sunnyvale, CA (US); Yiyang Joy Ding, Brooklyn, NY (US)

(73) Assignee: GOOGLE INC., Mountain View, CA (US)

(21) Appl. No.: 13/372,929

(22) Filed: Feb. 14, 2012

(51) Int. Cl. G06F 3/01; G06F 15/16

(52) U.S. Cl. 715/753

(57) ABSTRACT

A system and method for notifying members of a social network of a transit event is disclosed. In one example, the method comprises presenting, to the user in the display of the computer system, a geographical navigation interface including a visual indicator of a transit element, receiving, in the display, at least one long-press input provided by the user and directed to the visual indicator of the transit element, presenting at least one selection option for identifying a transit event pertaining to the transit element and at least one broadcast option for the user's social network, accepting, at least one selection option input corresponding to the transit event and at least one broadcast option input provided by the user, and causing the identified transit event to be broadcast to one or more members of the user's social network, based on the at least one broadcast option input.

### BACKGROUND

Public transportation or public transit is a shared passenger transportation service which is typically provided to the general public within populated areas. Public transit may include buses, trolleys, trams and trains, shuttles, the bike share programs, ferries, and water taxis. Public transit typically operates according to planned routes and predetermined timetables that are provided by the transport operator to allow travelers to plan their trip. Mobile computing devices can be used to obtain public transit information, including planned routes and predetermined timetables.

Such mobile computing devices can also be used for communicating with friends and acquaintances through social networks. Members of such social networks may be interested in sharing information with other members of the network. Users of these social networks can share with their friends and acquaintances information regarding real-time experiences as those experiences are happening. Typically, these real-time experiences are associated with a particular location, a particular service, or a particular event. Friends and acquaintances of the user who are located in nearby areas may be interested in receiving information relating to those locations, events and services.

### SUMMARY

Some mobile applications provide public transit travel directions to a user desiring to go from point A to point B, but do not provide traveling times based on real-time traveling conditions. Other mobile applications may use vehicle tracking systems to predict the arrival of the next public transit vehicle at any given node, such as a bus stop or a train stop. Using this mobile application user may infer a delay or a shut down from the delayed next arrival time. Additionally, public transit authorities may provide may provide alerts via various communication mediums notifying travelers of potential travel issues such as emergencies, approximate travel delays, transit advisories, and transit shut downs. Typically, because these alerts are provided by transit authorities, the dissemination of these alerts is delayed, commonly reaching the user after a point where the user can take an alternative route. Additionally, if a public transit service is shut down or delayed, the user receiving the alert would need to figure out alternative travel options and which of the options is optimal for travel. A user unfamiliar with the public transit system or the geographical area may have a hard time planning an alternative route.

Therefore, aspects and embodiments are directed to a system and method that provides real-time public transit information from members of the user's social network and determines the best alternative travel options for the user. According to one embodiment, the system includes a geographical navigation interface. The geographical navigation interface provides a selection option that allows the user to quickly input public transit event information pertaining to a location where public transit is affected. The system further includes a service that receives user inputted public transit event information and processes the event information to determine alternative routes for traveling directions. The selection option system eases the burden on the user to type in the information and provides normalized event data to the service for processing.

For users searching for directions, the service may provide a way to avoid public transit problem areas without inferring or accessing multiple applications. A user unfamiliar with the transit system may not be able to determine the optimal alternative travel route. Further, the service processes received events to determine whether the received public transit events are relevant and reliable and whether the public transit events should be used to determine an alternative route.

According to one embodiment, a method for notifying members of a social network of a transit event using a computer system, the computer system having a display, is disclosed. The method comprises presenting, to the user in the display of the computer system, a geographical navigation interface including a visual indicator of a transit element, receiving, in the display, at least one long-press input provided by the user and directed to the visual indicator of the transit element, and presenting to the user in the display, in response to accepting the at least one long-press input, at least one selection option for identifying a transit event pertaining to the transit element and at least one broadcast option for the user's social network. The method further comprises accepting, in the display, at least one selection option input corresponding to the transit event and at least one broadcast option input provided by the user, and causing the identified transit event to be broadcast to one or more members of the user's social network, based on the at least one broadcast option input.

In one example, the method may further comprise receiving, by a communication service, a plurality of transit events pertaining to at least one of a plurality transit elements associated with the at least one selection option input and the at least one broadcast option input. In this example, the method may further comprise determining a value of reliability associated with each of the plurality of public transit events. In addition, the method may further comprise adjusting the value of reliability associated with at least one of the plurality of transit events based on a subsequently received transit event.

In another example, the method may further comprise ranking the plurality of transit events based on the value of reliability for each of the plurality of transit events. In addition, the method may further comprise comprising adjusting a navigational tree based on at least one transit event of the plurality of transit events and the respective value of reliability. In this example, adjusting the navigational tree further includes adjusting at least one aspect of the plurality of transit elements. In addition, adjusting the navigational tree further includes adjusting at least one aspect of the plurality of transit elements for a predetermined period of time, and returning the navigational tree to a previous state after passage of the predetermined period of time.

In another example, the method may further comprise determining alternative navigation directions based on the at least one transit event of the plurality of transit events and the respective value of reliability. In this example, the method may further comprise presenting the alternative navigation directions to the user in the display of the computer system. In another example, presenting at least one selection option for the transit event may include presenting at least one standardized input option.

According to another embodiment, a system for notifying members of a user's social network of a transit event is disclosed. The system comprises a display, and a geographical navigation interface provided on the display, the geographical navigation interface including a visual indicator of a transit element. The geographical navigation interface is configured to receive at least one long-press input provided by the user and directed to the visual indicator of the transit element, present to the user in the display, in response to the at least one long-press input, at least one selection option for identifying a transit event pertaining to the transit element and at least one broadcast option for the user's social network, and accept the at least one selection option input corresponding to the transit event and at least one broadcast option input provided by the user.

The system further comprises a controller coupled to the geographical navigation interface and the display and configured to cause the identified transit event to be broadcast to one or more members of the user's social network, based on the at least one broadcast option input.

In one example, the system may further comprise a communication service configured to receive the at least one broadcast option input and a plurality of public transit events pertaining to at least one of a plurality of the transit elements associated with the at least one selection option input. In another example, communication service is further configured to determine a value of reliability associated with each of the plurality of transit events. In this example, the communication service is further configured to adjust the value of reliability associated with at least one of the plurality of transit events based on at least one subsequently received transit event.

In another example, the communication service is further configured to adjust a navigational tree based on at least one of the plurality of transit events and the respective value of reliability, wherein the navigational tree further includes at least one aspect of the plurality of the transit elements. In this example, the communication service is further configured to adjust at least one aspect of the plurality of transit elements for a predetermined period of time and return the navigational tree to a previous state after passage of the predetermined period of time.

In another example, the communication service is further configured to determine alternative navigation directions based on at least one of the plurality of transit events and the respective value of reliability, and wherein the geographical navigation interface is configured to present the alternative navigation directions to the user. In one example, the geographical navigation interface is configured to present at least one standardized input option included in the at least one selection option.

According to another embodiment, a computer readable medium having stored thereon sequences of instruction including instructions that will cause a processor to detect at least one long-press input directed to a visual indicator of a transit element, provided by a user in a geographical navigation interface of a computer system. The computer readable medium further including instruction that will cause a processor to determine at least one selection option for identifying a transit event pertaining to the transit element and at least one broadcast option for the user's social network, detect the at least one selection option input corresponding to the transit event and at least one broadcast option input provided by the user, and cause the identified transit event to be broadcast to at least one member of the user's social network, based on the at least one broadcast option input.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a diagram of a system for inputting public transit event information on a mobile device, according to one embodiment;

FIG. 2 is a diagram of a system for displaying public transit event information to members of a social network on a mobile device, according to one embodiment;

FIG. 3 is a diagram of a distributed communication system, according to one embodiment;

FIG. 4 is a diagram of a system for displaying directions for the user on the mobile device, according to one embodiment;

FIG. 5 is a flow diagram of a method of providing public transit event information to members of a social network, according to one embodiment; and

FIG. 6 is a block diagram of one example of a computer system that may be used to perform processes and functions disclosed herein.

### DETAILED DESCRIPTION

As described above, various mobile applications provide unconnected public transit information and event information from which the user can infer how to determine an optimal travel route. Accordingly, there is a need for an integrated mobile device application and service that provides real-time public transit information and determines the best alternative travel options for the user.

According to one embodiment, a distributed communication system includes a geographical navigation interface provided on a mobile device that presents a selection option to a user of the mobile device. The selection option allows the user to quickly input public transit event information pertaining to a location where public transit is affected. The public transit event information is transmitted to a service that broadcasts the information to the user's social network. In addition, the service may process and use the public transit event information to determine potential alternative routes. In one example, the service includes a routing engine that determines and provides directions for a potential alternative route for the user requesting directions that impact a problem area of the transit system. The routing engine allows the user to avoid the problem area without having to determine an alternative route themselves. Further, the system may include an event engine that processes received events according to various ranking methods. The event engine may be configured to determine whether the public transit events are relevant and reliable and whether the public transit events should be used to determine an alternative route.

Social networks may include any subscription-based or micro-blogging messaging services such as Twitter, provided by Twitter, Inc. of San Francisco, Calif. or Google+ provided by Google Inc. of Mountain View, Calif. In one example of the use of a micro-blogging site, a user of a micro-blogging application on a mobile device may submit short textual posts to a micro-blogging service. The posts may be transmitted from the mobile computing device to a central server where the posts are disseminated to computing devices of other users, including other users who have previously indicated an interest in “following” the posting user. Those “following” the posting user receive notices of new posts, such as in a stream presented to them on their computing devices. Users may view the posts by using the same micro-blogging application or logging into a website that displays a stream of posts by other people that use the micro-blogging service. Also, posts by other users can be presented to the viewing user according to automated algorithms (e.g., based on views, connections or ratings) and can further be provided to other people that do not “follow” the user. These other people may be in the user's extended network of friends (or “friends of friends”).

A transportation system may include various transit elements. Examples include infrastructure, such as highways, roads, rails, or seaways and vehicles traveling on the infrastructure, such as buses, trolleys, trams and trains, such as high speed trains or rapid transit (metro/subways/underground/“T”), cable cars, shuttles, bikes, pedicabs, road taxis, ride-share cars, ferries, and water taxis. The public transit system may further include transit elements that are nodes, such as train stations or bus stops, bike centers, ferry terminals as well as other nodes. In addition, the public transit system may include transit elements that are interchanges or hubs, where passengers can change travel modes, from passenger to vehicle, or from one vehicle to another (e.g. from train to bus). Further, the public transit system may include transit elements corresponding to other equipment that relates to public transportation, such as elevators, escalators, on-ramps, wheelchair accessible seats and entrances, stairs, HVAC units, lighting units, as well as other related equipment.

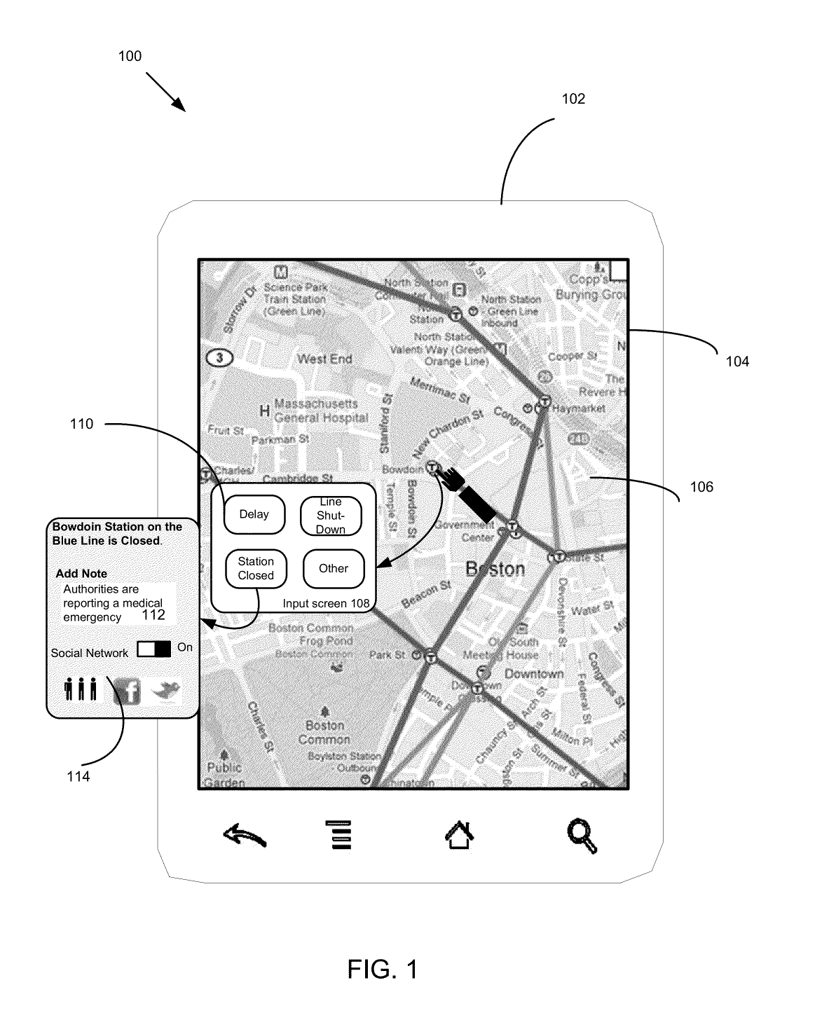

Referring to FIG. 1, there is illustrated one example of a system 100 for inputting public transit event information and providing this information to members of a social network. FIG. 1 shows one example of a display 102 of a mobile computing device 104 that presents a geographical navigation interface 106. The geographical navigation interface 106 may provide a map of an area around a user of the device 104, or an area to which the user intends to travel, layered with transit information and user-provided information. The geographical navigation interface 106 may provide for the user to input a search for a particular location of the map or alternatively, present on the map the user's current location. The geographical navigation interface 106 may be provided by a service over a distributed communication system 300, as further described below.

In one example, the map may be overlaid with information which may be provided on the geographical navigation interface in discrete layers. The layers may include public transit elements, such as public transit routes, public transit stops, and public transit equipment such as trains, buses, shuttles, as well as other transit related information. The layers may further include icons or other graphical element types indicating elements of the transit system, such as public transit stops and equipment. The elements may be presented as part of a map of the transit system or may be presented to indicate one or more routes utilizing elements of the transit system.

The layers and the icons may include geo-coded information representing the geographical location of the corresponding transit elements in the physical environment. For example, the geo-coded information may be in the form of latitude and longitude, or in the form of Global Positioning System (GPS) location information. The user of the device can select certain icons on one or more of these layers to see information about the icons. For example, the display shows an icon of a public transit stop on the map, shown as a circle with a letter “T.”

The geographical navigation interface may provide for the user an input component that allows the user to enter public transit event information. In one example, public transit event information may include security, maintenance, malfunction, weather and emergency related closures or delays, road hazards, alternative routes, change in service (e.g. change from local to express), information provided by public transit authorities, alerts, service advisories or service updates, as well as other public transit related information.

A user experiencing a public transit event or having knowledge of such an event may enter related information into the geographical navigation interface. In one example, the user may provide a one long-press input to the geographical navigation interface over the location on the map correlating to the existence of the event. The long-press input may be accomplished by pressing down and holding, using a fingertip or a stylus, on an area of a touch screen display. In one example, the user may hold the area for longer than a typical selection used for other features of the touch screen to distinguish the input.

As a result of the long-press an input screen 108 may be displayed. In one example of the long-press input, a user waiting for a train at a station may experience a delay in service of the train due to a malfunctioning train. The user may access the geographical navigation interface showing a map of the location near the user including an icon of the train station. The user may long-press (e.g. press and hold) the icon of the train station until the input screen is displayed. The input screen can allow the user to enter delay information associated with the train station.

FIG. 1 shows an input window 108 presented to the user as the result of the long-press on the geographical navigation interface of the mobile device. The input window 108 may be a single screen or a series of screens displayed for the user on the mobile device. The input window 108 may include various selection options 110 for the user to select in order to enter public transit event information. FIG. 1 shows the selection options as buttons; however any method of standardized input can be used including check boxes, radio buttons, as well as other methods. In one example, these various selection options may allow the user to quickly provide standardized event information without additional input. For example, the user may enter that a train is delayed by selecting the “delay” button, that a station is closed by selection “station closed” button or that the entire train line is shut down by selecting “line shut down” button. Alternatively, the user may customize the input of event information, by selecting “other” and manually entering the information. The user may also add a note 112 to either the standard input or the custom input to provide additional information regarding the event.

The input screen may allow the user to input any type of public transit event relating to any element of the public transit system, for example any event relating to infrastructure, nodes, hubs, vehicles or equipment or other event types. According to some embodiments, the geographic navigation interface may determine the location of the long-press on the map and whether there is a component of the public transit system situated in that location. In some embodiments, the input screen may be tailored to the type of component of public transit system present in the location of the long-press. For example, if the user long-presses on an icon of a node (e.g. a bus stop), the selection options presented on the public transit event information screen may be related to event information associated with that type of node.

In another example, the user may select any location on a map, the selection options may first prompt the user to select a type of component of the public transit system, for example infrastructure, vehicles, nodes, hubs, or equipment, then may present another set of selection options to enter the event related to the component. For example, the user may long-press a point along a road to indicate that a parade is occurring along the street and that buses traveling along that road are being rerouted to another road. In this example, the input screen may first present a series of selection options to determine that the user wishes to enter an event relating to a bus, then present another set of options allowing the user to enter road closure information.

According to at least one example, most commonly used selection options may be presented to the user. For example, commonly used selection options can be determined based on the number of inputs of a particular type from multiple users or from repeat use by the same user. Common selection options may be also determined by location and presented to the user when an area around the location is selected on the display.

After the information is entered by the user, the user may select a broadcast option 114. In one embodiment, the event information may then be broadcast to the user's social network according to settings selected by the user. In one example, the geographical navigation interface may automatically broadcast public transit event information to members of the user's social network. As shown in FIG. 1, the user may change automatic broadcast setting by toggling a switch from “on” into “off” position. In another example, the user may select which one(s) of the user's social networks to broadcast the public transit event information. For example, the social networks can be selected by highlighting or un-highlighting the icon associated with the particular social network.

The user can then cause the public transit event information to be broadcasted to one or more members of the user's social network. The public transit event information may then be received by the service as part of the distributed communication network and then transmitted to each of the respective social network servers selected by the user. The public event information received by the service may be processed by the service according to methods described below. The information may be streamed to each respective user according to methods used by each of the social network platforms. In at least one example, the user may have to authorize the service to have access to the user's social network information prior to broadcasting to the social network servers. The user may authorize access by providing the social network login and password information.

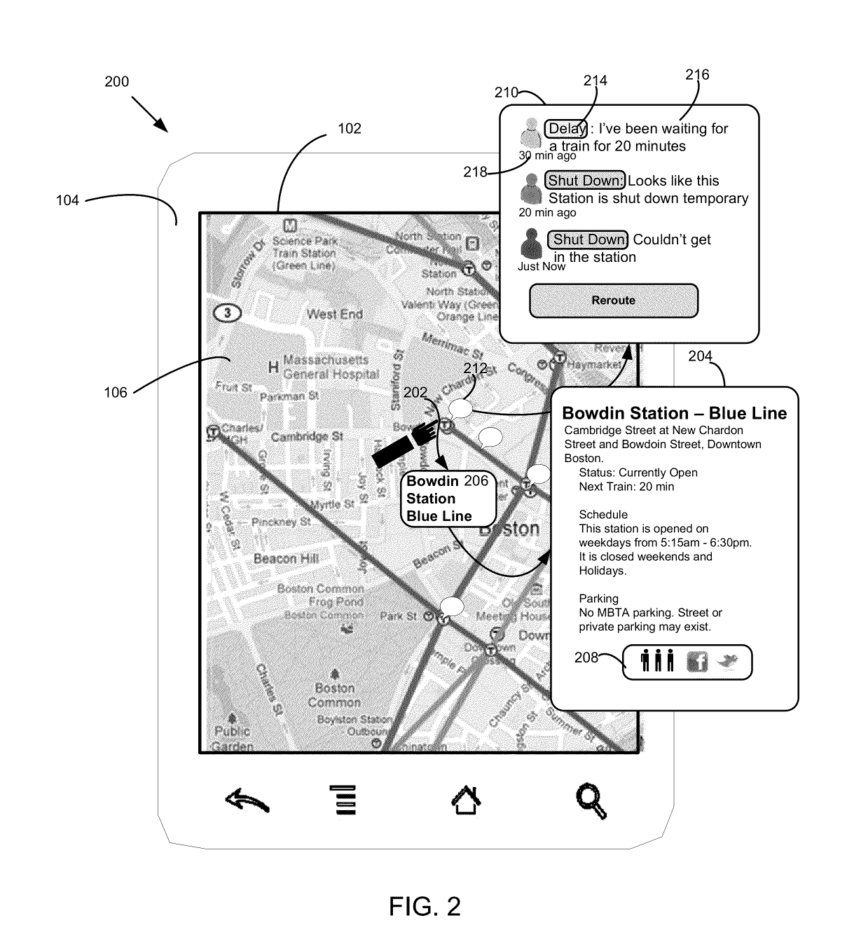

Referring to FIG. 2, there is illustrated one example of a system 200 for displaying public transit event information to members of a social network. FIG. 2 shows another example of the display 102 of the mobile computing device 104 that includes the geographical navigation interface 106. The geographical navigation interface 106 shows a map of an area around a user of the device 104, or an area to which the user intends to travel layered with public transit as well as user provided information. The map, the transit information, and the user provided information may be provided by a service over a distributed communication system, as further described below.

In one example, the map may be overlaid with information which may be provided on the display 102 in discrete layers. The layers may include public transit information and may further include icons indicating elements of the transit system, such as nodes, hubs, vehicles or equipment. The layers and the icons may include geo-coded information representing the geographical location of those layers and icons in the physical environment.

In addition, the layers may include transit directions provided to the user. For example, the user may desire to go from a point of origin (e.g. point A) to a destination point (e.g. point B). User enters locations of both points A and B and visual representation of transit directions are included as a layer over the map. The visual representation may include one or more suggested routes, including on or more alternative routes (e.g. bus versus train versus walking directions).

The user of the device can select certain icons on one or more of these layers to see information about the icons that other users have made to the system. For example, the geographic navigation interface 106 shows an icon of a public transit node 202 on the map, such as a train stop. The node is represented in FIG. 2 as a circle with a letter “T.” The user may select this icon of the node to obtain more information about the public transit station. For example, the train station may have a profile page 204 associated with the station. The information in the station's profile page 204 may have been initially provided or obtained directly from the transit authority by the mobile device using geo-coded location information. In one example, the information in the profile page 204 may be updated by asking the users of mobile devices to confirm the information as the users provide information associated with the station.

In one example, a user may click on the transit station to raise indicator 206 showing general information about the transit station, such as its name. The user may then tap the indicator to be presented with the profile page for the transit stop. The profile page 104 may include general information about the transit stop, such as photos of the exterior of the station, the status of the station, schedule of the associated transit line, information about the next train, or parking at the train station, as well as any other profile information. Also, the profile page 204 may present links 208 to various posts and related streams that have been associated with the station, as shown with icons on the bottom of the station profile page. The user can select the icons related to posts to display the posts in a post screen 210.

The posts and streams may also be presented to the user as one of the layers or icons in navigation interface 106. As shown in FIG. 2, the post icon 212 may be illustrated as a bubble proximate to the train station icon; however any visual indication can be used to indicate posts. The user may select the post icon 212 to access the posts screen 210 directly from the map. The location of the post icon 212 may be displayed in the map based on the location information received from user's mobile device 104 as the user posted the comments.

The posts screen 210 may display event information from users regarding the node 202 at the time of their location near the node, such as that the train is delayed, or that the train station is shut down. For each user, the post screen 210 may display the selection option 214, followed by the user's note 216. In one example, the selection option may be color coded based on severity. The post screen 210 can also display time information 218 associated with the posts, as well as information about the users creating the posts. The posts by users may be provided in response to other user's posts or they may be independent posts. The user's posting regarding the train station may be members of the user's social network. In particular, as shown FIG. 2, three members of the user's social network have commented on the train station.

According to some examples, the event information provided by the user's social network may be different than the transit information provided by the transit authorities. For example, as shown in FIG. 2, three members of the user's social network indicated that there is an issue with the train station, however, the transit authorities are reporting the station as open. In this example, the transit authority information is delayed making event information provided by the social network more reliable. Based on the information received from the post screen 210, the user may decide to find alternative travel options or routes. The post screen 210 may provided a reroute option for the user to find an alternative route.

The information that is presented on the map may be controlled by user and/or by the social network service. In one example, the posts that are displayed may be filtered by a user in various ways. For example, a viewing user may desire to see only posts from other users that the viewing user has affirmatively elected to “follow.” The viewing user may also see time-filtered posts, for example by selecting a graphical slider that can be displayed on the geographical navigation interface, so that posts in the last x hours or y days are displayed. In one example, the viewing user can also select to filter by post or user ranking level (e.g., three or above on a scale of five), as further described below. The geographical navigation interface can filter posts that have been ranked lower than a desired level and omit those posts from display to the user.

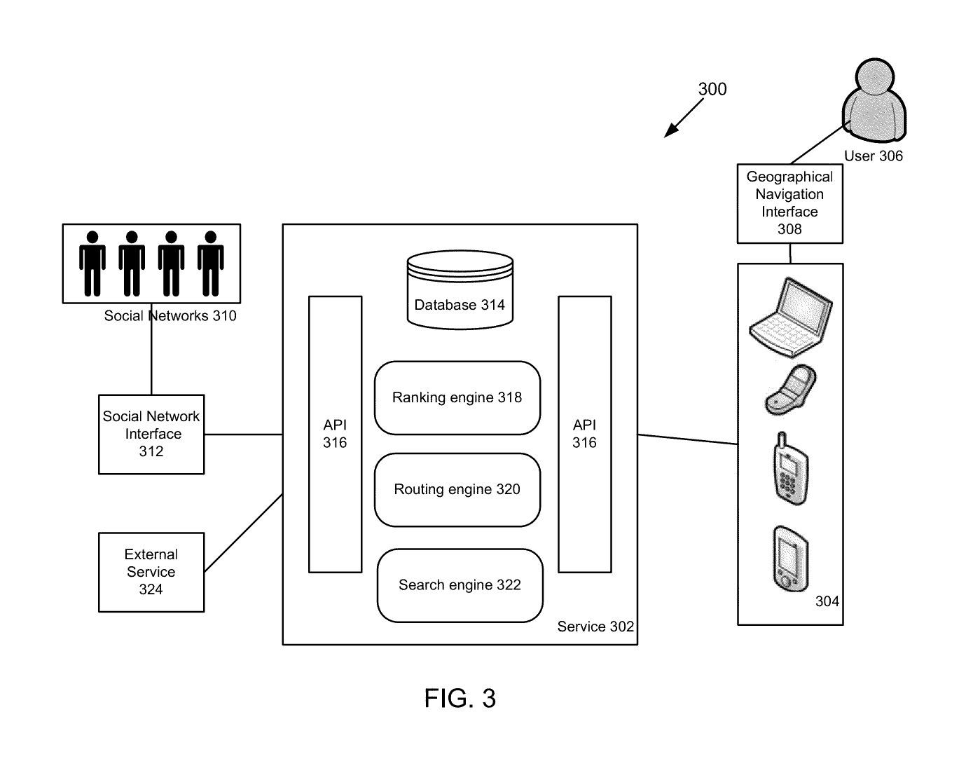

FIG. 3 shows a distributed system 300 including a service 302 for managing and enabling communication of information between users and various social networks. The distributed system can include the service 302, devices 304, users 306, a geographical navigation interface 308, social networks 310, and a social network interface 312. In one example, service 302 allows the users 306 to quickly post public transit event information to social networks and to quickly obtain public transit event information from social networks.

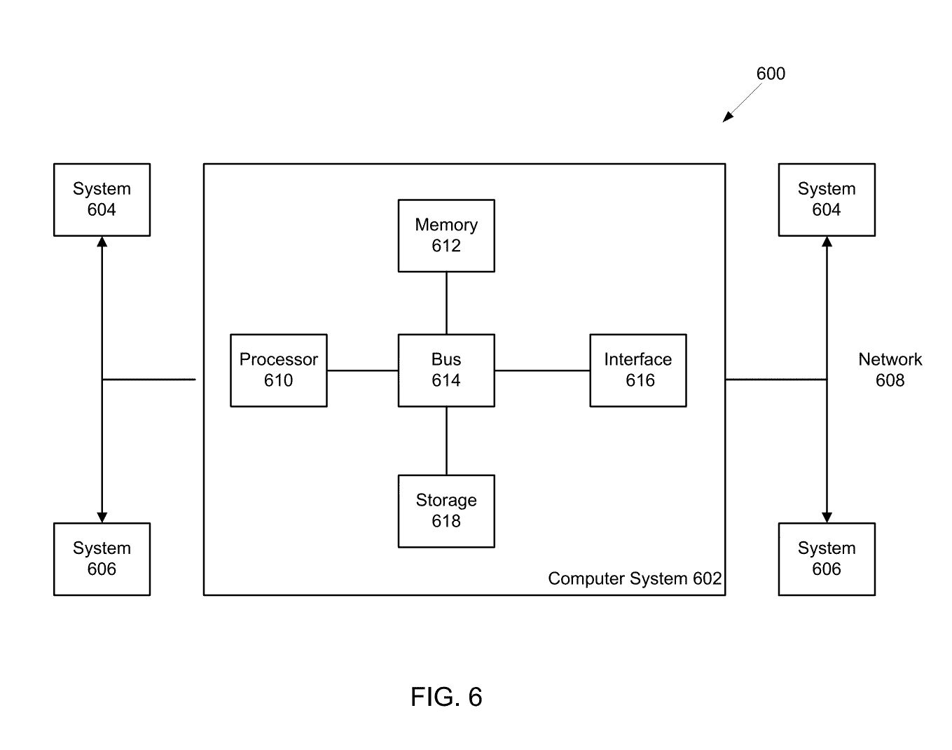

According to various examples, one or more components of the distributed system 300 can be implemented using one or more computer systems, such as the distributed computer system 600 discussed below with regard to FIG. 6. Thus, examples of the distributed communication system 300 include a variety of hardware and software components configured to perform the functions described herein and examples are not limited to a particular hardware component, software component or a particular combination thereof.

For instance, the user may provide one or more inputs to one of the devices 304, such as a cell phone, a smart phone, a PDA, a tablet computer, a laptop computer, a desktop computer or another system. The devices 304 may include a component, such as circuits, to determine the geographic location of the device. For example, mobile device 304 may include a GPS receiver. The component may include software for determining the position of the device based on signals received at a cell phone's antenna from one or more cell phone towers. In accordance with one aspect of the system and method, mobile device 304 includes a routine for periodically uploading its geographic location to the service 302. The routine may also include instructions for requesting and downloading maps and directions. Both the routine and the instructions may be presented in a single application, such as a mobile map or geographical navigation application.

The service 302 may include a database 314, an Application Programming Interface (API) 316, a ranking engine 318, a routing engine 320 and a search engine 322. These elements of service 302 can be provided using a computing system such as computer system 600 of FIG. 6. Users may interact with the devices 304 using the geographical navigation interface 308, which may be provided on the devices 304. The geographical navigation interface 308 may allow for inputs using keyword searches, geographical map searches and inputs, location based searching (e.g. within 2 mile radius of the present location), category selections (such as “train station”), and other methods of inputting search parameters. The search queries are transmitted to the search engine 322 of the service 302, which may return search results comprising of one or more hits meeting the search criteria.

The API 316 can serve as an interface between the service 302 and various software programs and interfaces and further facilitate their interaction. In one example, the API 316 can interface components of the service 302 and the applications and software programs used by the devices 304, and/or the social networks 310. The API 316 can include one or more discrete interfaces, for example, a user interface for interacting with the geographical navigation interface, a social network interface for interacting with one or more social network services. The service can further provide one or more related services through the API. In one example, the service can include a service for providing geographical navigation or directions to users via the mobile devices.

The API may further retrieve transit information from various external services 324. For example, transit information from various transit authorities, such as station information, route information, schedules, station shut-downs or re-routing information, as well as real-time travel or arrival times. Transit information may also be obtained from other services such as public transit tracking services. This information may be processed by the service 302 and used by the ranking engine 318 and/or the routing engine 320, as further described below. The transit information may also be displayed to the user via the graphical navigation interface 308.

External services 324 may further include various location-based services that may be integrated with posts or comments, such as by identifying the locations (e.g., latitude and longitude coordinates) from which posts or comments are made. The service 302 may receive location information about a user of the geographical navigation interface 308. For example, when a user submits public transit event information, geo-coordinates for the user may be provided with the post (e.g., via the GPS receiver on the user's device 304) or may be determined for the user by the service 302 (e.g., via cell tower or access point identification or triangulation). For example, the geo-location information may be an estimated latitude and longitude of the device 304 and information identifying an accuracy of the estimation. Because privacy is a concern, users may choose to opt out of sharing the geo-coordinates of their location; alternatively, a user's location may not be shared unless the user expressly opts in after being provided notice of how his or her location will be used.

The service 302 can be capable of storing information in the database 314, for instance, relating to users, social networks, transit event information, transition authorities, navigation information including the navigational tree, and transit profile information. The user information, for example, may include user identification information, previous event information submitted by the user, user's authentication information to various social networks, user preferences and settings, including previously selected broadcasting options, previously obtained directions and routing options, as well as current and past location information of the user's device. As mentioned above, users may also choose to opt out of having their user information stored in the database 314.

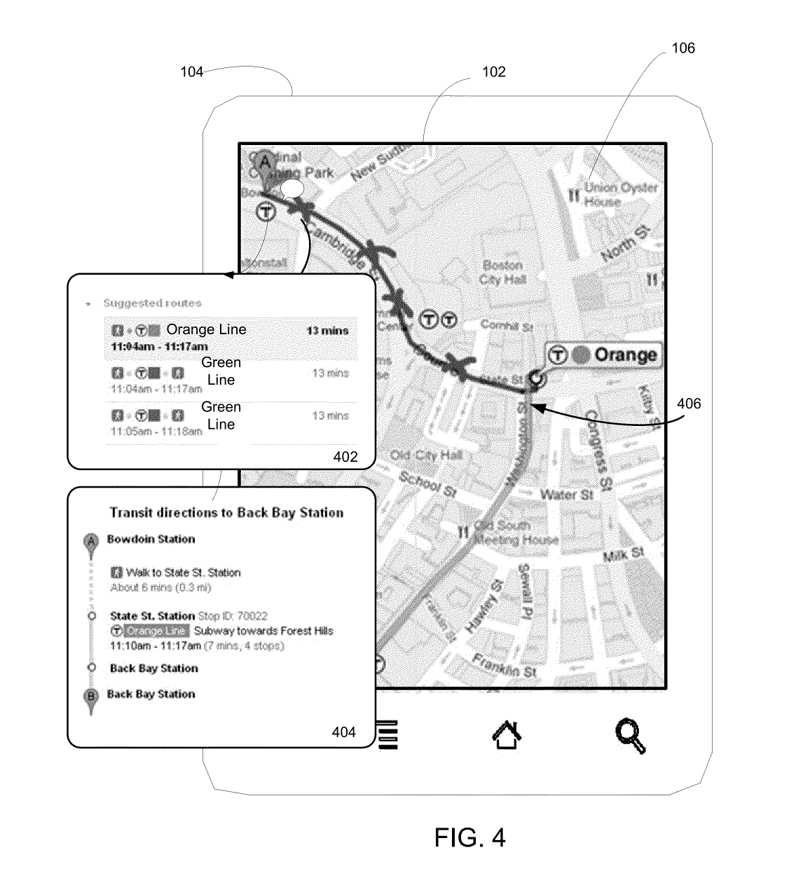

Referring again to FIG. 3, according to various embodiments, the routing engine 320 may use the transit event information to provide directions to a user of the geographical navigation interface 106. As described above, the user may request traveling directions from a point of origin to a destination in the geographical navigation interface 106, via public transportation services. The geographical navigation interface 106 may provide the directions to the user graphically as a layer on the map. FIG. 4 shows one example of the geographical navigation interface 106 displaying directions for the user. The geographical navigation interface 106 may provide a suggested route screen 402, which may include different suggested routes, including different public transportation services (e.g. travel by orange line or green line). Travel times, including approximate arrival time, may be displayed along with different traveling options may be displayed on the suggested route screen 402. The user may select one of the suggested routes and the geographical navigation interface 106 may provide directions for the suggested route. The directions may be in the form of text 404 describing every step of the transit path (e.g. “turn-by-turn” direction). The directions may also be visual 406, provided on the map as lines indicating the path of travel.

Turning back to FIG. 3, the event engine 318 may process public transit event information received from users according to sets of logic rules. In one example, the event engine 318 may aggregate and normalize one or more of the same public transit events received from different users, such as multiple users reporting a station shut down. In another example, the event engine 318 may also aggregate and normalize different public transit events received from different users, such as one user reporting a train delay and another user reporting a train shut down. The event engine 318 may provide the aggregated event information in the form of a summary to the routing engine to provide routing information based on the aggregated events.

According to various examples, the event engine 318 may rank user provided public transit event information according to logic rules or logic tables. The event engine 318 may assign a value to each event received based on a determined measure of reliability. In one example, another value may be may be assigned according to subsequently received events, the subsequent value may be higher or lower based on reliability. For example, the event engine may assign a first value based on receiving of a delay event received at a particular bus stop from a first user, and subsequently assign a second value based on receiving another delay event at the same location by another user, where the second value may be higher than the first value. According to at least one example, the event information may not be provided to the routing engine until a threshold number of events is received (e.g. two or more). In one example, the events may need to be closely related received near similar locations.

In yet another example, events confirmed by another source may have a higher value assigned to them. For example, a station shut down event may be confirmed by information received from a transit authority or verified using transit tracking information. In another example, different users may have different values of reliability assigned to them. For example, directly connected members of the user's social network (members “following” the user, or are “friends” of the user, or those within the user's “circle”) may have a higher value assigned than members of the user's extended social network (e.g. members “not following” the user, members in various degrees of separation, “friends of friends” or those outside of the user's circle). In addition, users may have a value assigned to them based on previous accurate reporting of transit event information independently or subsequently confirmed. Ranking information may be provided to the geographical navigation interface and displayed to the user in association with events displayed.

In one example, the routing engine 320 may adjust travel information relating to the public transportation system and provide alternative directions based on the user-submitted transit event information. The routing engine 320 may include a navigation tree that includes aspects of the transit system, infrastructure, vehicles, nodes, hubs, and equipment, and the interconnections between the aspects. The navigation tree may also include a hierarchy and logic rules for optimized travel along the aspects of the transit system. For example, train travel may be higher on the hierarchy than bus travel, which may be higher on the hierarchy than walking. The logic rules may determine how a traveler reaches from point A to point B. The navigational tree may further include details of how each aspect of the tree effects over aspects. For example, if one node of the train system is disabled (e.g. a train broken down in a station) how are the rest of the nodes affected (e.g. can the remaining train station be operational).

The routing engine 320 may adjust the navigational tree or the hierarchy of travel based on the public transit event information received and the ranking assigned to the public transit event. For example, if one or more users indicated that a particular train line is not in service, the routing engine 320 may temporarily remove the transit line on the navigational tree. Other examples of adjusting the navigational tree may include removing a station or a stop, such as a train or a bus stop if the station or stop are shut-down, removing a public transit route if the route is shut down, changing travel times for services that are delayed, rerouted or changed to express or local status as well as other changes to the travel information. Based on the adjusted navigation tree, the routing engine 320 may determine alternative travel directions for a requesting user.

Referring again to FIG. 4, one example of adjusting travel information and displaying the adjusted travel information in the geographical navigation interface 106 is illustrated. In the example shown, a service train (e.g. “Blue line”) is determined to be shut down based on event information received from various users. The geographical navigation interface 106 shows the service line as shut down (indicated with “X” marks in FIG. 4). In this example, the user is requesting public transportation directions from Bowdin Station to Back Bay Station. The routing engine 320 provides alternative directions shown in 404. In this example, the user is directed to walk to the next closest train line (e.g. Orange or Green line).

The routing engine 320 may include a set of logic rules for adjusting navigational tree. In one example, the logic rules may be based on the type of event received, the aspect of the transit system affected, the related aspects of the transit systems, and the ranking information associated with the event or the submitting user. For example, if the routing engine 320 receives a train delay event for a train route, the routing engine 320 may continue to provide the train route as one of the travel options, but may adjust travel times and arrival times associated with the train service.

In another example, the routing engine 320 may include another set of logic rules for restoring the navigation tree to original form as the public transit event concludes. For example, if the routing engine 320 receives a train shut down event due to a power shut down in the train station, the routing engine 320 may temporarily remove the train route from the travel options for a specific period of time (e.g. 20, 30, or 60 minutes). At the end of the period the train route may return to original status and the navigational tree may be returned to its original form. In this example, if the routing engine 320 receives another event relating to the same train shut down event during the period of time, the routing engine 320 may continue to suspend the train route in the navigational tree.

If a user's request for directions overlaps one or more of the adjusted transportation services, the routine engine 320 may calculate alternative transportation directions and provide those alternative directions to the user. For example, if a train station is shut down, the routing engine 320 may direct the user to walk to the next train station, take a shuttle, or a bus.

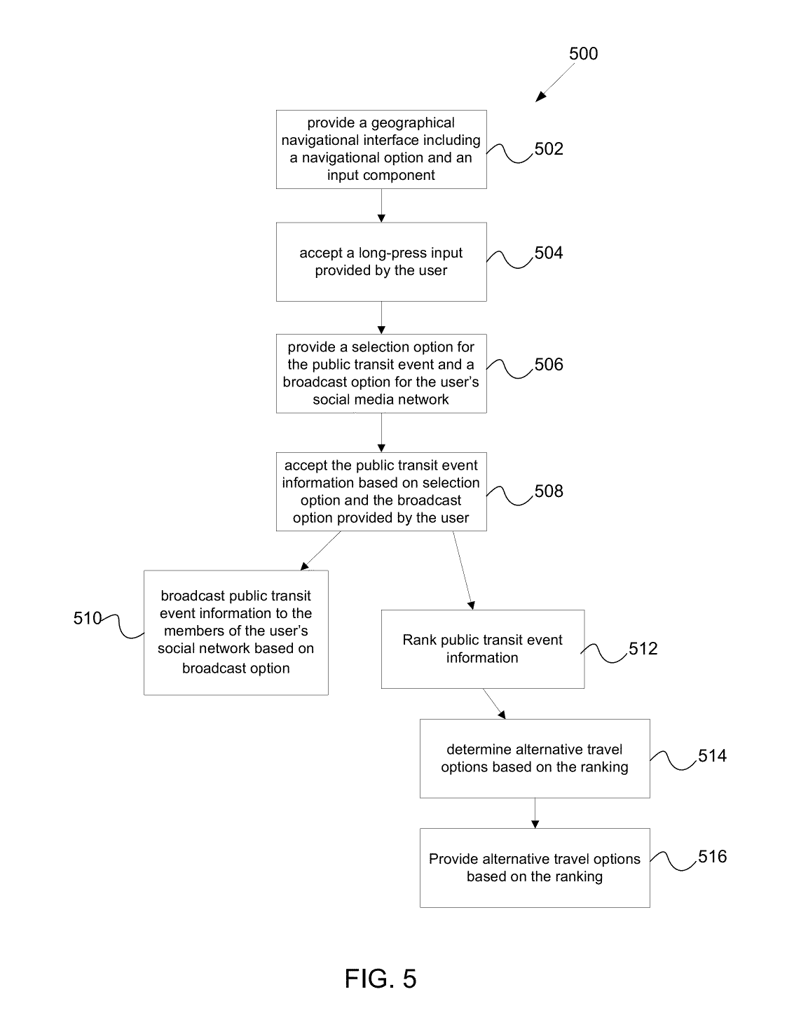

FIG. 5 shows one example of a method 500 of notifying members of a social network of a public transit event for example by using the mobile devices and distributed communication systems described above with reference to FIGS. 1-4 and the computer systems described below with reference to FIG. 6.

In step 502, the mobile device presents, to a user in the display of the mobile device, a geographical navigational interface. The geographical navigation interface includes a navigational option and an input component. The input component allows the user to provide a one long-press input to the navigation option. In step 504, the mobile device accepts, in the display of the mobile device the long-press input provided by the user. As described above, the long-press may be accomplished by pressing down and holding, using a fingertip or a stylus, on an area of a touch-sensitive display or on a touch-sensitive input device mapped to a display.

In step 506, in response to accepting the long-press input, the mobile device presents to presenting to the user in the display one or more selection options for the public transit event and a broadcast option for the user's social media network. The selection options may include ways of selecting different types of public transit events. The different types of public transit events may be specific to locations of the navigation option. In one example, the public transit events may be specific to nodes, infrastructure, vehicles, or equipment associated with the public transit event. For instance, the events may be specific to the transit element represented at a location on the display for which the long-press touch was directed. The selection options may include one or a series of screens that “walk” the user through selecting the corresponding public transit event.

In step 508, the mobile device accepts the selection option and the broadcast option provided by the user in the display. The selection option accepted by the mobile device corresponds to the public transit event experienced by the user. As described above, the selection option may also be standardized by presenting one of the standard selection options to the user. The selection option may also be customizable by the user by providing for the user to enter “other” and input a custom description of the public transit event. The selection option and the broadcast option may be provided to the service 302 and can be stored on the database of the service 302.

In step 510, the public transit event associated with the selection option may be broadcast to members of the of the user's social network based on the broadcast option. As described above, the broadcast option may include a selection by the user of the social networks the user desires to broadcast the public transit information. The broadcast option may further allow the user to filter the types of social networks and the members of those networks who are to receive the broadcast. For instance, the public transit event may be provided to one or more social networks 310 via the service 302. As another example, the public transit event may be provided directly to social network(s) 310 from the user's device, for example by invoking functions of an API made available by social network 310.

In some implementations, method 500 ends at step 510 when information about the public transit event is provided for broadcast to one or more social networks. However, in some implementations the method continues to steps 510-516 so that information is used by service 302. In step 512, the selection option associated with the public transit event is processed by the service 302. As described above, the public transit events received may be ranked based on a measure of reliability. Based on the ranking, the service 302 may determine whether route or travel options need to be adjusted and determine alternative travel options (step 514). In step 516, a user requesting directions impacting adjusted travel options can receive alternative travel options, which are provided by the service 302.

### Example Computer Implementations

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the implementation is not limited to any particular distributed architecture, network, or communication protocol. Furthermore, aspects in accord with the present invention may be implemented as specially-programmed hardware and/or software.

FIG. 6 shows a block diagram of a distributed computer system 600, in which various aspects and functions in accord with the present invention may be practiced. The distributed computer system 600 may include one more computer systems. For example, as illustrated, the distributed computer system 600 includes three computer systems 602, 604 and 606. As shown, the computer systems 602, 604 and 606 are interconnected by, and may exchange data through, a communication network 608. The network 608 may include any communication network through which computer systems may exchange data. To exchange data via the network 608, the computer systems 602, 604 and 606 and the network 608 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA HOP, RMI, DCOM and Web Services.

Computer systems 602, 604 and 606 may include mobile device such as cellular telephones. The communication network may further employ a plurality of mobile access technologies including 2nd (2G), 3rd (3G), 4th (4G or LTE) generation radio access for cellular systems, WLAN, Wireless Router (WR) mesh, and other communication technologies. Access technologies such as 2G, 3G, 4G and LTE and future access networks may enable wide area coverage for mobile devices. For example, the network may enable a radio connection through a radio network access such as Global System for Mobil communication (GSM), General Packet Radio Services (GPRS), Enhanced Data GSM Environment (EDGE), Wideband Code Division Multiple Access (WCDMA), among other communication standards. Network may include any wireless communication mechanism by which information may travel between the devices 104 and other computing devices in the network.

To ensure data transfer is secure, the computer systems 602, 604 and 606 may transmit data via the network 608 using a variety of security measures including TSL, SSL or VPN, among other security techniques. While the distributed computer system 600 illustrates three networked computer systems, the distributed computer system 600 may include any number of computer systems, networked using any medium and communication protocol.

Various aspects and functions in accord with the present invention may be implemented as specialized hardware or software executing in one or more computer systems including the computer system 602 shown in FIG. 6. As depicted, the computer system 602 includes a processor 610, a memory 612, a bus 614, an interface 616 and a storage system 618. The processor 610, which may include one or more microprocessors or other types of controllers, can perform a series of instructions that manipulate data. The processor 610 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 610 is connected to other system placements, including a memory 612, by the bus 614.

The memory 612 may be used for storing programs and data during operation of the computer system 602. Thus, the memory 612 may be a relatively high performance, volatile, random access memory such as a dynamic random access memory (DRAM) or static memory (SRAM). However, the memory 612 may include any device for storing data, such as a disk drive or other non-volatile storage device, such as flash memory or phase-change memory (PCM). Various embodiments in accord with the present invention can organize the memory 612 into particularized and, in some cases, unique structures to perform the aspects and functions disclosed herein. Components of the computer system 602 may be coupled by an interconnection element such as the bus 614. The bus 614 may include one or more physical busses (for example, busses between components that are integrated within a same machine), and may include any communication coupling between system placements including specialized or standard computing bus technologies such as IDE, SCSI, PCI and InfiniBand. Thus, the bus 614 enables communications (for example, data and instructions) to be exchanged between system components of the computer system 602.

Computer system 602 also includes one or more interface devices 616 such as input devices, output devices and combination input/output devices. The interface devices 616 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 616 allow the computer system 602 to exchange information and communicate with external entities, such as users and other systems.

Storage system 618 may include a computer-readable and computer-writeable nonvolatile storage medium in which instructions are stored that define a program to be executed by the processor. The storage system 618 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 610 or some other controller may cause data to be read from the nonvolatile recording medium into another memory, such as the memory 612, that allows for faster access to the information by the processor 610 than does the storage medium included in the storage system 618. The memory may be located in the storage system 618 or in the memory 612. The processor 610 may manipulate the data within the memory 612, and then copy the data to the medium associated with the storage system 618 after processing is completed. A variety of components may manage data movement between the medium and the memory 612, and the invention is not limited thereto.

Further, the invention is not limited to a particular memory system or storage system. Although the computer system 602 is shown by way of example as one type of computer system upon which various aspects and functions in accord with the present invention may be practiced, aspects of the invention are not limited to being implemented on the computer system, shown in FIG. 6. Various aspects and functions in accord with the present invention may be practiced on one or more computers having different architectures or components than that shown in FIG. 6. For instance, the computer system 602 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 602 may include an operating system that manages at least a portion of the hardware placements included in computer system 602. A processor or controller, such as processor 610, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for notifying members of a user's a social network of a transit event, using a computer system having a display, the method comprising:
presenting, to the user in the display of the computer system, a geographical navigation interface including a visual indicator of a transit element associated with a public transit service, the transit element comprising a station, stop, terminal, interchange, or hub;
receiving, in the display, at least one long-press input provided by the user and directed to the visual indicator of the transit element;
presenting to the user in the display, in response to accepting the at least one long-press input, two or more selection options for identifying a transit event and at least one broadcast option for the user's social network, the transit event comprising information experienced by a user relating to a delay of the public transit service and being associated with the public transit service;
accepting, in the display, at least one selection option input corresponding to the transit event and at least one broadcast option input provided by the user; and
causing the identified transit event to be broadcast to one or more members of the user's social network, based on the at least one broadcast option input.

2. The method of claim 1, further comprising receiving, by a communication service, a plurality of transit events pertaining to at least one of a plurality transit elements associated with the at least one selection option input and the at least one broadcast option input.

3. The method of claim 2, further comprising determining a value of reliability associated with each of the plurality of transit events.

4. The method of claim 3, further comprising adjusting the value of reliability associated with at least one of the plurality of transit events based on a subsequently received transit event.

5. The method of claim 3, further comprising ranking the plurality of transit events based on the value of reliability for each of the plurality of transit events.

6. The method of claim 3, further comprising adjusting a navigational tree based on at least one transit event of the plurality of transit events and the respective value of reliability.

7. The method of claim 6, wherein adjusting the navigational tree further includes adjusting at least one aspect of the plurality of transit elements,

8. The method of claim 7, wherein adjusting the navigational tree further includes adjusting at least one aspect of the plurality of transit elements for a predetermined period of time; and returning the navigational tree to a previous state after passage of the predetermined period of time.

9. The method of claim 6, further comprising determining alternative navigation directions based on the at least one transit event of the plurality of transit events and the respective value of reliability.

10. The method of claim 9, further comprising presenting the alternative navigation directions to the user in the display of the computer system,

11. The method of claim 1, wherein presenting at least one selection option for the transit event includes presenting at least one standardized input option.

12. A system for notifying members of a user's social network of a transit event, the system comprising:
a display;
a geographical navigation interface, provided on the display, including a visual indicator of a transit element associated with a public transit service, the transit element comprising a station, stop, terminal, interchange, or hub, the geographical navigation interface configured to:
receive at least one long-press input provided by the user and directed to the visual indicator of the transit element;
present to the user in the display, in response to the at least one long-press input, two or more selection options for identifying a transit event and at least one broadcast option for the user's social network, the transit event comprising information experienced by a user relating to a delay of the public transit service and being associated with the public transit service; and
accept at least one selection option input corresponding to the transit event and at least one broadcast option input provided by the user; and
a controller coupled to the geographical navigation interface and configured to cause the identified transit event to be broadcast to one or more members of the user's social network, based on the at least one broadcast option input.

13. The system of claim 12, further comprising a communication. service configured to receive the at least one broadcast option input and a plurality of transit events pertaining to at least one of a plurality of the transit elements associated with the at least one selection option input.

14. The system of claim 13, wherein the communication service is further configured to determine a value of reliability associated with each of the plurality of transit events.

15. The system of claim 14, wherein the communication service is further configured to adjust the value of reliability associated with at least one of the plurality of transit events based on at least one subsequently received transit event.

16. The system of claim 14, wherein the communication service is further configured to adjust a navigational tree based on at least one of the plurality of transit events and the respective value of reliability, wherein the navigational tree further includes at least one aspect of the plurality of the transit elements.

17. The system of claim 16, wherein the communication service is further configured to adjust at least one aspect of the plurality of transit elements for a predetermined period of time and return the navigational tree to a previous state after passage of the predetermined period of time.

18. The system of claim 14, wherein the communication service is further configured to determine alternative navigation directions based on at least one of the plurality of transit events and the respective value of reliability, and wherein the geographical navigation interface is configured to present the alternative navigation directions to the user.

19. The system of claim 12, wherein the geographical navigation interface is configured to present at least one standardized input option included in the at least one selection option.

20. A non-transitory computer readable medium having stored thereon sequences of instruction including instructions that will cause a processor to:
detect at least one long-press input directed to a visual indicator of a transit element associated with a public transit service, provided by a user in a geographical navigation interface of a computer system, the transit element comprising a station, stop, terminal, interchange, or hub;
determine two or more selection options for identifying a transit event and at least one broadcast option for the user's social network, the transit event comprising information experienced by a user relating to a delay of the public transit service and being associated with the public transit service;
detect at least one selection option input corresponding to the transit event and at least one broadcast option input provided by the user; and
cause the identified transit event to be broadcast to at least one member of the user's social network, based on the at least one broadcast option input.
